(19) United States
(12) Patent Application Publication
(10) Pub. No.: US 2006/0002247 A1
(43) Pub. Date: Jan. 5, 2006

(54) Optical pickup and optical recording and/or reproducing apparatus adopting the same

(75) Inventors: Tae-kyung Kim, Seoul (KR); Seok-jung Kim, Suwon-si (KR); Hee-kyung Kim, Anyang-si (KR); Woo-seok Choi, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/172,901

(22) Filed: Jul. 5, 2005

(30) Foreign Application Priority Data
Jul. 5, 2004 (KR) 2004-51978

(51) Int. Cl. G11B 7/00

(52) U.S. Cl. 369/44.11; 369/44.37; 369/112.01

(57) ABSTRACT

An optical pickup and an optical recording and/or reproducing apparatus adopting the same are provided. The optical pickup includes an optical unit, first and second objective lenses, and an optical path switching unit. The optical unit illuminates light onto an information storage medium and receives light reflected from the information storage medium to detect an information signal and/or an error signal. The first and the second objective lenses focus incident light to form a light spot on an information storage surface of the information storage medium. The optical path switching unit selectively directs the light incident from the optical unit to one of the first and second objective lenses. In the optical pickup, since the light quantity directed to a plurality of objective lenses may be maximized, optical efficiency is increased and thus high-speed operation may be attained.

### CROSS-REFERENCE TO RELATED APPLICATION

This application claims the benefit of Korean Application No. 2004-51978, filed Jul. 5, 2004 in the Korean Intellectual Property Office, the disclosure of which is incorporated herein by reference.

### BACKGROUND OF THE INVENTION

1. Field of the Invention

An aspect of the present invention relates to an optical pickup and an optical recording and/or reproducing apparatus adopting the same, and, more particularly, to an optical pickup and an optical recording and/or reproducing apparatus adopting the same having a plurality of objective lenses.

2. Description of the Related Art

In an optical recording and/or reproducing apparatus to record arbitrary information and/or reproduce the recorded information to and/or from an optical disc, which is an optical information storage medium, using a light spot condensed by an objective lens, a recording capacity is determined by a size of a generated light spot. The light spot size S is given by
S∝λ/NA Equation 1
where λ is the wavelength of light used by the apparatus and NA is the numerical aperture of the objective lens. Therefore, a light source with a short wavelength such as a blue laser and an objective lens having an NA greater than 0.6 must be adopted in order to reduce the light spot size that is focused onto the optical disc when a high density optical disc is used.

Recently, a Blu-ray disc (BD) standard has been suggested that uses a light source with a wavelength of approximately 405 nm and an objective lens with an NA of 0.85. The BD standard uses an optical disc with a capacity of approximately 25 giga bytes (GB) and a thickness (i.e., the interval between a light-incident plane and an information storage plane, corresponding to the thickness of a protection layer in this case) of 0.1 mm, has been suggested. Further, a high definition DVD (HD DVD) standard has been suggested that uses a light source with a wavelength equal to that used by the BD standard, an objective lens with an NA of 0.65. The HD DVD standard uses an optical disc with a capacity of approximately 15 GB and a thickness (i.e., the interval between a light-incident plane and an information storage plane, corresponding to the thickness of a substrate in this case) of 0.6 mm.

In the field of digital versatile discs (DVDs), trends tend to occur in which diverse standards exist together. Occasionally, these trends are repeated. Therefore, a device to make two optical disc standards compatible each other in one system or apparatus is needed. For example, the DVD standards use a light source with similar wavelengths, an objective lens with similar NAs, and an optical disc substrate with similar thicknesses; only a track pitch or an optical disc structure is different. Therefore, since an operation of condensing light emitted from a light source onto an optical disc is almost the same regardless of the optical disc standard, a method of performing focusing and tracking in a compatible manner depending on track pitches has been considered. However, since a thickness of an optical disc is different in the case of next-generation DVD standards, such as the BD and HD DVD standards, the generation of spherical aberration due to differences in the thicknesses of the optical discs may be severe.

There exists a method of using a holographic optical element that compensates for spherical aberration. Use of a holographic optical element that compensates for the spherical aberration in a system that uses two light sources will be described below. In the case of a DVD/compact disc (CD) compatible apparatus, since the reflection ratio of a recordable optical disc is relatively remarkably reduced with respect to light sources having a wavelength different from a wavelength prescribed for each optical disc standard, two light sources must be used. For example, since reflection ratios of a DVD-R and a CD-R to be used in one time recording are remarkably reduced when light having a wavelength that is different from a standard wavelength is used, light sources having wavelengths of 650 nm and 780 nm must be used. In this case, compatibility may be effectively achieved by using a diffraction angle of the holographic optical element depending on the wavelength (650 nm and 780 nm) and a refraction angle difference resulting from a difference between the refraction indexes according to wavelength.

A first diffraction beam of the holographic optical element may have a high diffraction efficiency at the two wavelengths of 650 nm and 780 nm, as illustrated in FIG. 1. In the case that the recordable optical disc is excluded, there exists a method of making CD-family optical discs that are compatible using one light source, e.g., a DVD light source. In this case, zeroth-order light and first-order light, divided by the holographic optical element, may be effectively used to compensate for spherical aberration due to a difference of thicknesses between two optical disc's substrates. However, since light that is emitted from a single source is divided into two beams of light, optical efficiency is reduced by more than half.

Since the next-generation DVD standards, i.e., the BD and HD DVD standards use light sources with substantially similar wavelengths, using the above-described method to accomplish compatibility using a diffraction angle of the holographic optical element depending on the different wavelengths that are used and a refraction angle difference resulting from a difference between the refraction indexes according to wavelength is difficult. Further, the method of compensating for the spherical aberration due to a difference in thickness of two optical discs by allowing light emitted from one light source to be diffracted into the zeroth-order and the first-order light beams using the holographic optical element has a low optical efficiency. Therefore, applying the method to a high-speed apparatus that requires greater light quantity is difficult.

### SUMMARY OF THE INVENTION

Aspects of the present invention provide an optical pickup and an optical recording and/or reproducing apparatus capable of compatibly using two information storage media of different standards where wavelengths of light being radiated towards the media are substantially similar, and where thicknesses of the information storage media and NAs of objective lenses are different.

Further, the optical pickup and optical recording and/or reproducing apparatuses according to aspects of the present invention have high optical efficiency and are able to operate at a high speed.

According to an aspect of the present invention, there is provided an optical pickup, which includes: an optical unit to illuminate light onto an information storage medium and to receive light reflected back by the information storage medium to detect an information signal and/or an error signal; first and second objective lenses to focus incident light to focus to form a light spot onto an information storage surface of the information storage medium; and an optical path switching unit to electrically switch the proceeding direction of the light so that the light incident from the optical unit proceeds toward one of the first and second objective lenses.

According to an aspect of the invention, the optical unit includes a blue light source emitting light of a blue wavelength region and one of the first and the second objective lenses is formed in accordance with a BD standard and the other is formed in accordance with an HD DVD standard, whereby the BD and the HD DVD may be compatibly adopted.

According to an aspect of the invention, the optical unit further includes at least one of a red light source to emit light of a red wavelength region and an infrared light source to emit light of an infrared wavelength region, and the optical unit is configured to adopt compatibly at least one of a DVD and a CD.

According to an aspect of the invention, the objective lens appropriate for the HD DVD standard of the first and second objective lenses is formed to adopt compatibly at least one of a DVD and a CD.

According to an aspect of the invention, the optical pickup further includes a reflection mirror reflecting light that has transmitted the optical path switching unit.

According to an aspect of the invention, the first and second objective lenses are installed in a single lens holder along a radial direction of the information storage medium.

According to an aspect of the invention, the optical path switching unit includes a Bragg grating that can be electrically switched.

According to an aspect of the invention, the Bragg grating includes: a liquid crystal layer that is interposed between a pair of substrates, and having liquid crystal drops entangled with chains and a polymer filling a space between the liquid crystal drops, a refraction index difference between the liquid crystal drops and the polymer being adjusted by an electrical signal to selectively transmit or reflect/diffract incident light; and transparent electrodes formed on inner surfaces of the substrate producing an electric field in the liquid crystal layer.

According to an aspect of the invention, the Bragg grating is configured to perform a transmission operation when a voltage is applied and perform a diffraction operation when the voltage is not applied.

According to an aspect of the invention, the optical path switching unit includes: a selective half-wave plate selectively changing polarization of light of a specific wavelength region incident from the optical unit by being electrically driven; and a polarizing beam splitter selectively transmitting or reflecting the light incident from the selective half-wave plate depending on the polarization of the light.

According to an aspect of the invention, the light of the specific wavelength region is light of a blue wavelength region.

According to an aspect of the invention, the selective half-wave plate is a liquid crystal plate formed to selectively act as a half-wave plate by being electrically driven.

According to another aspect of the present invention, there is provided an optical recording and/or reproducing apparatus, which includes: an optical pickup that can move along a radial direction of an information storage medium to reproduce information recorded on the information storage medium or to record information; and a controller controlling the optical pickup, the optical pickup including the optical pickup of the present invention.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph of the diffraction efficiency of zeroth-order light and first-order light according to wavelength in a general holographic optical element;

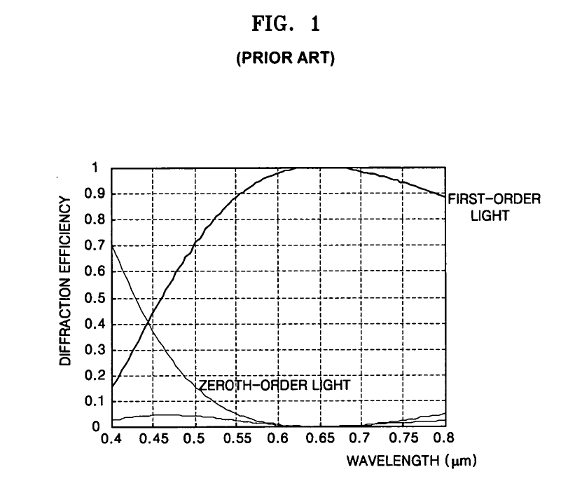

FIG. 2 is a schematic view of an optical pickup according to an aspect of the present invention;

FIGS. 3A and 3B are views illustrating the structure of a liquid crystal layer of a switchable Bragg grating and selective transmitting and reflecting/diffracting in the switchable Bragg grating according to an aspect of the present invention;

FIGS. 4A and 4B are schematic views illustrating proceeding light paths switched by an optical path switching unit in the optical pickup illustrated in FIG. 2 according to an aspect of the present invention;

FIG. 5 is a schematic view of optical composition of an optical pickup according to an embodiment of the present invention;

FIG. 6 is a perspective view of the optical pickup illustrated in FIG. 5;

FIG. 7 is a perspective view of an optical pickup according to another embodiment of the present invention;

FIG. 8 is a schematic view of optical composition of an optical pickup according to another embodiment of the present invention;

FIGS. 9A and 9B are schematic views illustrating proceeding light paths switched by an optical path switching unit in the optical pickup illustrated in FIG. 8; and

FIG. 10 is a schematic view of an optical recording and/or reproducing apparatus adopting an optical pickup according to the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

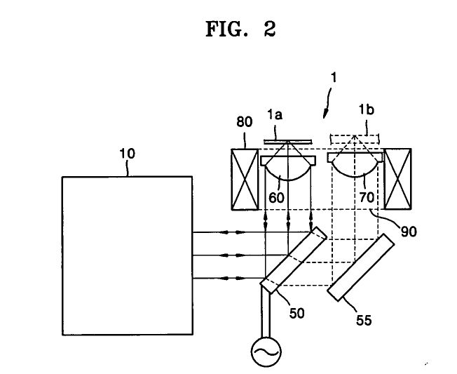

FIG. 2 is a schematic view of an optical pickup according to an embodiment of the present invention. Referring to FIG. 2, the optical pickup includes: an optical unit 10 to illuminate light onto an information storage medium (i.e., an optical disc 1), and to receive light reflected from the optical disc 1 so as to detect an information signal and/or an error signal; first and second objective lenses 60 and 70 to condense incident light to form a light spot onto an information storage surface of the optical disc 1; and an optical path switching unit 50 to electrically switch the path of the light that is incident from the optical unit 10 so as to allow the light to selectively progress to one of the first and the second objective lenses 60 and 70. The optical disc 1 can be a Blu-RAY (BD) disc 1a or a HIGH DEFINITION DVD (HD DVD) disc 1b. However, it is understood that the optical disc 1 can also be other types of discs compatible with the wavelength and/or the N/A substantially that of the BD or the HD DVD.

The optical unit 10 includes at least one light source, where that at least one light source includes a light source emitting light in a blue wavelength region (e.g., with a wavelength of 405 nm) appropriate for a BD 1a and an HD DVD 1b, which are next-generation DVD. Various embodiments of the optical unit 10 will be described below.

The first objective lens 60 may be formed in accordance with a BD standard and the second objective lens 70 may be formed in accordance with an HD DVD standard.

That is, the first objective lens 60 may be optimized for the optical disc 1 having a thickness of approximately 0.1 mm and for light in the blue wavelength region, and have an NA of 0.85. The second objective lens 70 may be optimized for the optical disc 1 having a thickness of approximately 0.6 mm and for light of the blue wavelength region, and have an NA of 0.65. As an alternative, the first objective lens 60 may be formed in accordance with the HD DVD standard and the second objective lens 70 may be formed in accordance with the BD standard. Further, as described below, the objective lens 60 or 70 formed in accordance with the HD DVD standard may be adaptable so as to be compatible with the DVD, or CD or the like standard. However, it will be assumed that the first and the second objective lenses 60 and 70 are appropriate for the BD and the HD DVD standards, respectively.

In this case, the optical pickup of the present invention is compatibly adapted to be usable with the BD 1 a and the HD DVD 1b. While not required in all aspects, the first and the second objective lenses 60 and 70 are disposed along a radial direction of the optical disc 1 in a single lens holder 90, and are driven in a focus direction, tracking direction and/or tilt direction by an actuator 80. When the first objective lens 60 is formed appropriately for the BD standard, the first objective lens 60 is disposed farther from the center of the optical disc 1 than the second objective lens 70. As an alternative, the first objective lens 60 can be disposed closer from the center of the optical disc 1 than the second objective lens 70.

While not required in all aspects, the first and the second objective lenses 60 and 70 are installed in the single lens holder 90 considering the difference in thicknesses and the difference in working distances between the BD 1a and the HD DVD 1b. For example, when information is recorded onto or reproduced from the HD DVD 1b, which is relatively thick, the first objective lens 60 may be installed in the lens holder 90 so as to be separated from the optical disc 1b y a greater distance than an original working distance of the first objective lens 60 so that a collision between the first objective lens 60 and the HD DVD 1b may be prevented. The first and the second objective lenses 60 and 70, the single lens holder 90 mounting the objective lenses 60 and 70, and a magnetic circuit portion of the actuator 80 installed in the single lens holder 90 constitute a moving unit of an optical pickup assembly.

The optical path switching unit 50 switches between operations of transmitting and reflecting incident light using an electrical signal. For example, the optical path switching unit 50 operates as a reflection mirror in a power-off state to direct the incident light to the first objective lens 60 and to transmit the incident light in a power-on state to direct the incident light to the second objective lens 70.

When the first objective lens 60 is formed in accordance with the BD standard, the optical path switching unit 50 is operated to direct the incident light to the first objective lens 60 when information is recorded onto or reproduced from the BD 1a and to direct the incident light to the second objective lens 70 when information is recorded onto or reproduced from an optical disc of the other standards (e.g., one of the HD DVD 1b, DVD, and CD).

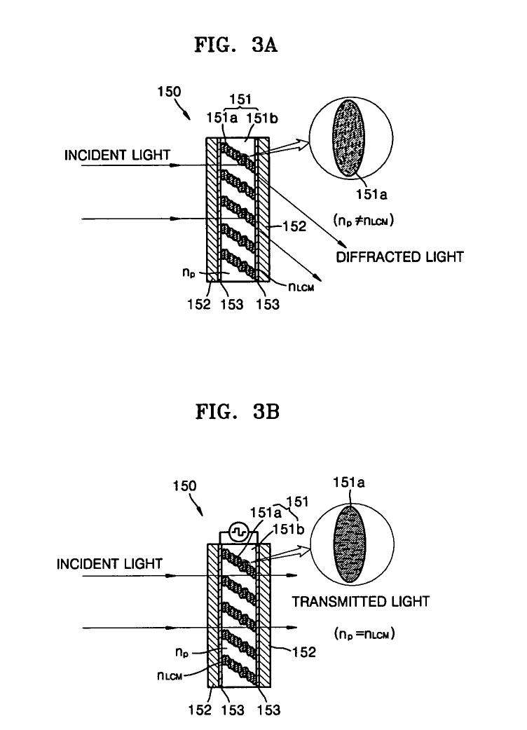

According to another aspect, the optical path switching unit 50 is an electrically switchable Bragg grating (ESBG) 150 as shown in FIGS. 3A and 3B. Unlike the holographic optical element, refractive index modulation is possible with the ESBG 150. The ESBG 150 includes a liquid crystal layer 151 that is interposed between transparent glass or plastic substrates 152 and selectively transmits or diffracts incident light according to an electrical signal. The ESBG 150 further includes an indium tin oxide (ITO) transparent electrode 153 coated on an inside surface of the substrate 152 to apply an electric field to the liquid crystal layer 151.

Referring to FIGS. 3A and 3B, the liquid crystal layer 151 includes: fine liquid crystal drops 151a entangled with chains disposed at predetermined intervals; and a polymer 151b filling the space between the fine liquid crystal drops 151a. That is, the fine liquid crystal drops 151a are densely distributed between the transparent ITO-coated substrates 152 and the polymer 151b fills between the fine liquid crystal drops 151a to form a Bragg surface.

As is described above, the ESBG 150 includes the polymer 151b which is relatively pure as well as planes of the dense fine liquid crystal drops 151a alternately distributed with constant intervals between the adjacent planes of the fine liquid crystal drops. Therefore, when the refractive index n_{LCM} of the fine liquid crystal drops 151a is different from the refractive index nₚ of the polymer 151b, a volume phase hologram is generated so that a diffraction operation is generated. That is, the fine liquid crystal drops 151a that are disposed at constant interval act like a diffraction grating to diffract and reflect the incident light. In the liquid crystal layer 151 having the above-described structure, selective transmission and reflection of the incident light are performed using the following principle. If a voltage is not applied to the liquid crystal layer 151 (voltage-off state), since the refractive index n_{LCM} of the fine liquid crystal drops 151a is different from the refractive index np of the polymer 151b, the liquid crystal layer 151 diffracts/reflects the incident light as illustrated in FIG. 3A.

Referring to FIG. 3B, when a predetermined voltage is applied to the liquid crystal layer 151, since an optical axis of liquid crystal molecules constituting the liquid crystal drops 151a is aligned so that the refractive index nLCM of the liquid crystal molecules is substantially similar as that of the refractive index np 151b of the polymer, the diffraction grating resulting from a difference between the refractive indexes of the liquid crystal drops 151a and the polymer 151b disappears. Thus, the liquid crystal layer 151 becomes transparent and transmits almost all of the incident light without diffraction. As is described above, the ESBG 150 is configured to transmit light when a voltage is applied thereto and to diffract light when the voltage is not applied thereto.

The optical pickup further includes a reflection mirror 55 to reflect light that has passed through the optical path switching unit 50 to the second objective lens 70.

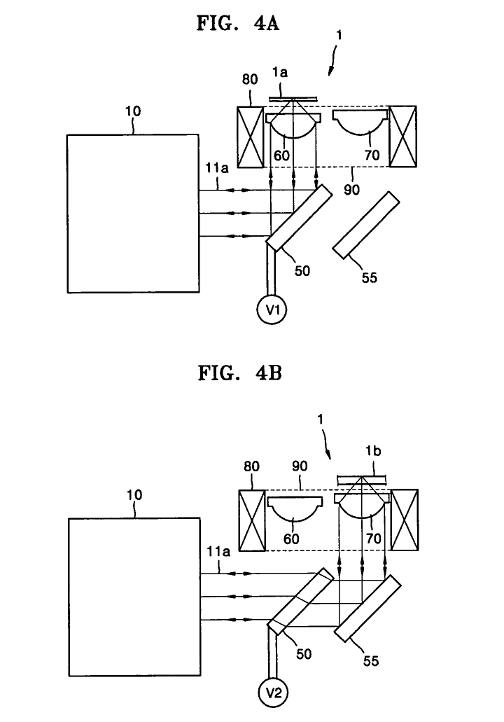

The optical pickup according to the embodiment of the present invention as described above selectively transmits or reflects incident light by electrically driving the optical path switching unit 50. For example, referring to FIG. 4A, when information is recorded onto or reproduced from the BD 1a, if the optical path switching unit 50 receives a first voltage V1 (e.g., the optical patch switching unit is in a power-off or a lower power state), the optical path switching unit 50 reflects all of the light that is incident from the optical unit 10 to the first objective lens 60. Further, referring to FIG. 4B, when information is recorded onto or reproduced from the HD DVD 1b, if the optical path switching unit 50 receives a second voltage V2 (e.g., the optical path switching unit is in a power-on or higher power state), the optical path switching unit 50 may transmit all of the light that is incident from the optical unit 10 to the second objective lens 70.

As is described above, in the optical pickup of an aspect of the present invention, since quantities of light directed to the BD 1a and the HD DVD 1b respectively may be maximized, high optical efficiency is achieved. Thus, high-speed recording/reproducing, which requires a large quantity of light, may be obtained. The reason a large quantity of light is required for high-speed recording/reproducing is that as the speed increases a time during which a light spot, which is illuminated to a predetermined position of the optical disc 1, decreases the light quantity illuminated per unit time must be increased to obtain the optical power required to perform recording and/or reproducing operations.

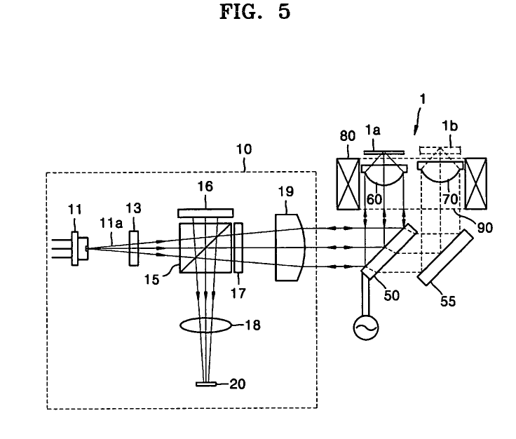

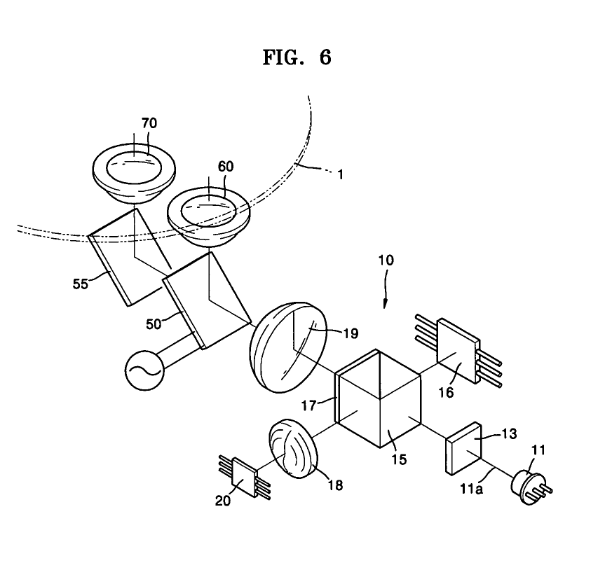

A variety of embodiments for optical construction of the optical pickup according to aspects of the present invention will be described below. FIG. 5 is a schematic view of optical composition of an optical pickup according to an embodiment of the present invention and FIG. 6 is a perspective view of the optical pickup illustrated in FIG. 5. The same reference numerals are used for the elements substantially performing the same or similar operations as those illustrated in FIG. 2 and descriptions thereof will be omitted.

Referring to FIGS. 5 and 6, the optical pickup according to the present embodiment includes a blue light source 11 to emit a first light 11a in a blue wavelength region (e.g., with a wavelength of 405 nm in accordance with standards of next-generation DVD's, e.g., the BD 1a and the HD DVD 1b) and may be adapted to be compatible with the BD 1a and the HD DVD 1b. Further, the first objective lens 60 may be optimized for the BD 1a and the second objective lens 70 may be optimized for the HD DVD 1b. In that case, the optical path switching unit 50 is formed and operated to reflect the first light 11a incident from the optical unit 10 when the BD 1a is applied and to transmit the first light 11a incident from the optical unit 10 when the HD DVD 1b is applied.

In the optical pickup according to the embodiment of FIGS. 5 and 6, the optical unit 10 includes: the blue light source 11 to emit the first light 11a in the blue wavelength (i.e., with the wavelength of 405 nm in accordance with the next-generation DVDs); a first optical path changing unit to change the proceeding path of the incident first light 11a; and a photo detector 20 to receive the first light 11a reflected from the optical disc 1 so as to detect an information reproducing signal and/or an error signal. Further, the optical unit 10 further includes a grating 13 to divide the first light 11a emitted from the blue light source 11 into at least three light beams. The optical unit 10 further includes a collimating lens 19 to collimate the first light 11a emitted from the blue light source 11. The optical unit 10 further includes a detection lens 18 arranged between a polarizing beam splitter 15 and the photo detector 20. However, it is understood that the optical pickup 10 can be otherwise constructed.

The illustrated first optical path changing unit includes: the polarizing beam splitter 15 transmitting or reflecting the incident first light 11a according to the light 11a's polarization state; and a quarter-wave plate 17 formed in accordance with the wavelength of the first light 11a to change the polarization of the first light 11a. The grating 13 is disposed along an optical path between the blue light source 11 and the polarizing beam splitter 15. The grating 13 is configured so that tracking error signal detection using a 3-beam method or a differential push-full method is possible. However, it is understood that the first optical path changing unit can be otherwise constructed.

While not required in all aspects, the detection lens 18 may be an astigmatism lens (e.g., a cylindrical lens), generating astigmatism in the incident first light 11a to direct a focus error signal using an astigmatism method.

In order to control the optical power of the blue light source 11, the illustrated optical unit 10 further includes a photo detector 16 for monitoring the first light by detecting the first light 11a emitted from the blue light source 11 and partially reflected by the polarizing beam splitter 15.

In the above-described optical pickup, the optical path switching unit 50 is operated to reflect the first light 11a incident from the optical unit 10 to the first objective lens 60 when the BD 1a is applied and transmit the first light 11a incident from the optical unit 10 to the reflection mirror 55 when the HD DVD 1b is applied. The light is then reflected by the reflection mirror 55 to the second objective lens 70. The first light 11a reflected by the BD 1a or the HD DVD 1b is reincident on the optical unit 10 by following reverse path. Thus, the optical pickup of the present embodiment may be compatible and applied to operate with both the BD and the HD DVD.

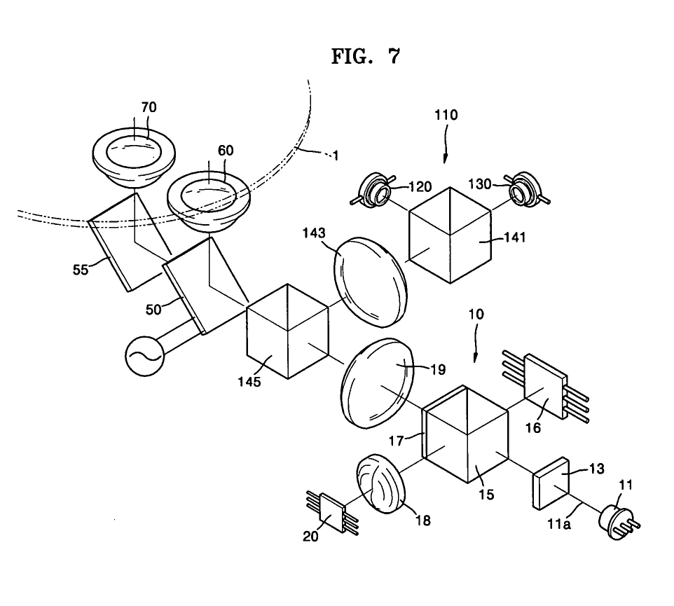

FIG. 7 is a perspective view of an optical pickup according to another embodiment of the present invention. The optical pickup shown in FIG. 7 has an optical construction capable of being compatible with a DVD and a CD as well as the BD 1a and the HD DVD 1b in comparison with the optical pickup embodiment of FIGS. 5 and 6. Here, the same reference numerals are used for the elements performing substantially the same operations as those of FIGS. 2 and 5 and descriptions thereof will not be repeated.

In an optical pickup according to the embodiment of FIG. 7, an optical unit 110 includes: first and second optical modules 130 and 120 to emit second and third light with wavelengths appropriate for a DVD and a CD, respectively, and to receive the second and the third light after the first and second light beams are reflected from the optical disc 1 so as to detect an information reproducing signal and/or an error signal; a beam splitter 141 to separate and combine optical paths of the second and third light emitted from the first and second optical modules 130 and 120; a collimating lens 143 to collimate the second and third light emitted from the first and second optical modules 130 and 120; and a beam splitter 145 to cause the second and third light emitted from the first and second optical modules 130 and 120 to proceed to the optical path switching unit 50 by way of the same optical path as the first light 11a emitted from the blue light source 11.

The first and the second optical modules 130 and 120 are respectively a red light source to emit light in a red wavelength region (e.g., with a wavelength of 650 nm in accordance with information recording and/or reproducing standards of a DVD), and an infrared light source to emit light in an infrared wavelength region (e.g., with a wavelength of 780 nm in accordance with information recording and/or reproducing standards of a CD).

while not required in all aspects, a hologram optical module for a DVD and a hologram optical module for a CD may be provided for the first and the second optical modules 130 and 120, respectively. A hologram optical module includes: a light source; a photo detector; and a hologram to transmit light that is emitted from the light source, and to transmit diffracted light that is reflected from the optical disc 1 toward the photo detector. As the hologram optical module is well known in the art, a more detailed description and illustration thereof are omitted. Moreover, it is understood that elements of the module 120 or 130 can be separately provided and need not be provided in a single module.

In the illustrated embodiment of FIG. 7, the second objective lens 70 is formed in accordance with information recording and/or reproducing standards of an HD DVD and to be able to be compatible with a DVD and a CD. Since the HD DVD standard is the same as or similar to the DVD standard in terms of the thickness of the optical disc and the NA of the objective lens used, compatibility between the HD DVD and the DVD may be achieved using one objective lens. Further, designing the objective lens to be compatible with a CD is similarly possible.

In the embodiment of FIG. 7, the optical pickup is able to be compatible with a DVD and a CD as well as a BD and an HD DVD.

An optical pickup according to the present invention may also be formed to be compatible with a BD, an HD DVD, and a DVD. Referring to FIG. 7, the optical pickup need not include one optical module of the first and the second optical modules 130 and 120 and the beam splitter 141 in FIG. 7. Indeed, the second objective lens 70 may be configured in accordance with information recording and/or reproducing standards of an HD DVD and may be adapted to be compatible with one of a DVD and a CD. The optical pickup according to aspects of the present invention may be formed to include an optical system that is compatible with a DVD and/or a CD, in addition to an optical system for a BD and an HD DVD. For example, in FIG. 7, the optical system may be modified such that the beam splitter 145 is excluded, an objective lens for a DVD and/or a CD is separately provided, the optical paths of the second and the third light emitted from the first and the second optical modules 130 and 120 are separated/combined by the beam splitter 141, and the second and third light is collimated by the collimating lens 143 and is incident on the objective lens for the DVD and/or the CD. In that case, the optical pickup according to the present invention includes at least three objective lenses. Since such an optical arrangement can be sufficiently inferred from the above description, detailed description thereof will be omitted.

In the above description, it has been has been assumed that the first objective lens 60 on which the light reflected by the optical path switching unit 50 is incident is appropriate for the BD 1a and the second objective lens 70 on which the light that has passed through the optical path switching unit 50 is incident is appropriate for the HD DVD 1b. However, it is possible that the first objective lens 60 is formed appropriately for the HD DVD 1b and the second objective lens 70 is formed appropriately for the BD 1a.

The operation of the optical pickup according to an aspect of the present invention as described above will now be described using the optical configuration illustrated in FIG. 7 as an example. When a BD 1a is mounted in the optical recording and/or reproducing apparatus, the blue light source 11 is operated to emit the first light 11a and the optical path switching unit 50 is operated to reflect the incident first light 11a. For example, the optical path switching unit 50 is maintained in a power-off state. A linearly polarized component of the first light 11a emitted from the blue light 11 passes through the polarizing beam splitter 15 and is converted into circularly polarized light by the quarter-wave plate 17. The first light 11a is collimated by the collimating lens 19, passes through the beam splitter 145 and is incident on the optical path switching unit 50. The incident first light 11a is reflected by the optical path switching unit 50 and is focused in the form of a light spot on the information storage surface of the BD 1a by the first objective lens 60. The first light 11a, converted into different circularly polarized light by being reflected by the information storage surface of the BD 1a, follows the original optical path in the opposite direction back to the quarter-wave plate 17, gets converted into different linearly-polarized light while passing through the quarter-wave plate 17 and, having been reflected by the polarizing beam splitter 15, is then received by the optical detector 20.

On the other hand, if an HD DVD 1b is mounted in the optical recording and/or reproducing apparatus, the blue light source 11 is operated to emit the first light 11a and the optical path switching unit 50 is operated to transmit the incident first light 11a. For example, the optical path switching unit 50 is maintained in a power-on state. In this time, the optical path and polarization of the first light 11a are changed in the same manner as when the BD 1a is used. After that, the first light 11a is transmitted through the optical path switching unit 50, reflected to the second objective lens 70 by the reflection mirror 55, condensed by the second objective lens 70, and focused in the form of a light spot on the information storage surface of the HD DVD 1b. The first light 11a reflected by the information storage surface of the HD DVD 1b follows the original optical path in the opposite direction and is reflected by the polarizing beam splitter 15 and is received at the photo detector 20.

When a DVD is mounted in the optical recording and/or reproducing apparatus, the first optical module 130 is operated to emit the second light and the optical path switching unit 50 is operated to transmit the incident second light. For example, the optical path switching unit 50 is maintained in a power-on state. The second light that is emitted from the first optical module 130 passes through the beam splitter 141, is collimated by the collimating lens 143 and is incident on the beam splitter 145. The incident second light is reflected by the beam splitter 145, passes through the optical path switching unit 50, is reflected by the reflection mirror 55, and is incident on the second objective lens 70. The incident second light is condensed by the second objective lens 70 and focused in the form of a light spot on the information storage surface of the DVD. The second light reflected by the information storage surface of the DVD follows the original optical path back to the first optical module 130. When a CD is mounted in the optical recording and/or reproducing apparatus, the second optical module 120 is operated to emit the third light and the optical path switching unit 50 is operated to transmit the incident third light. For example, the optical path switching unit 50 is maintained in a power-on state. The third light emitted from the second optical module 120 is reflected by the beam splitter 141, collimated by the collimating lens 143 and incident on the beam splitter 145. The incident third light is reflected by the beam splitter 145, passes through the optical path switching unit 50, is reflected by the reflection mirror 55 and is incident on the second objective lens 70. The incident third light is condensed by the second objective lens 70 and focused in the form of a light spot on the information storage surface of the CD. The third light reflected by the information storage surface of the CD follows the original optical path back to the second optical module 120.

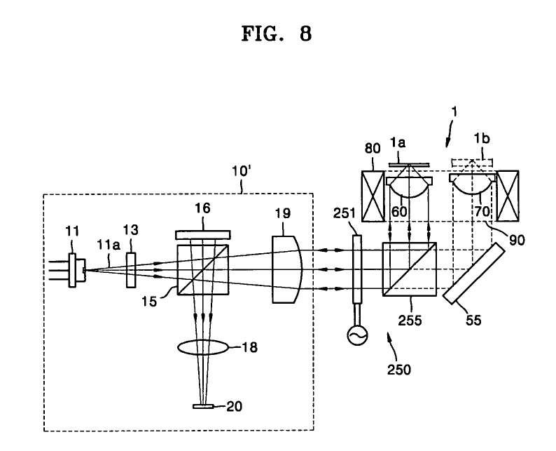

FIG. 8 is a schematic view of an optical pickup according to another embodiment of the present invention. Unlike the optical pickup of FIGS. 5 and 6, the optical pickup illustrated in FIG. 8 includes an optical path switching unit 250 different from the optical path switching unit 50 and wavelength plates 17 are arranged between the optical path switching unit 250 and the first and the second objective lenses 60 and 70, respectively, instead of being disposed in the optical unit 10′. Here, the same reference numerals are used for elements performing substantially the same functions as those of FIGS. 2 and 5, and description thereof will not be repeated.

Referring to FIG. 8, the optical path switching unit 250 includes: a selective half-wave plate 251 to selectively change the polarization of light in a specific wavelength region to which light whose optical path is to be switched belongs by an electrical driving; and a polarizing beam splitter 255 to selectively transmit or reflect light incident from the selective half-wave plate 251 depending on the polarization of the light. As with the embodiments of FIGS. 5-7, when the blue light source 11 to emit the first light 11a in a blue wavelength region (i.e., with a wavelength of 405 nm) appropriate for next-generation DVD (i.e., the BD 1a and the HD DVD 1b), is provided, the light of the specific wavelength region is the light of the blue wavelength region and the selective half-wave plate 251 selectively acts as a half-wave plate for the light of the blue wavelength region. The selective half-wave plate 251 may be a liquid crystal plate configured to selectively act as a half-wave plate according to which it is electrically driven.

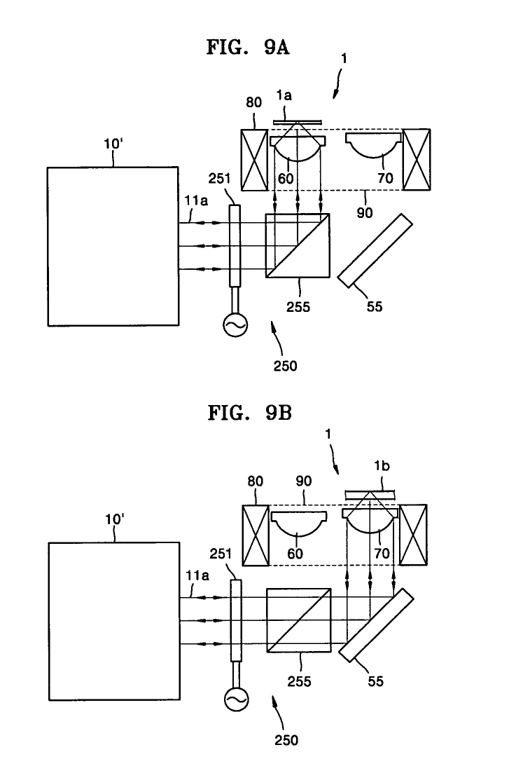

The incident light of a specific wavelength region (e.g., the incident light 11a of blue wavelength region), may be selectively sent to the first or the second objective lens 60 or 70 as illustrated in FIGS. 9A and 9B by the optical path switching unit 250. Referring to FIG. 9A, when information is recorded and/or reproduced with respect to the BD 1a, if the selective half-wave plate 251 receives a first voltage V1 (e.g., the selective half-wave plate 25 is in a power-off or lower power state), the p-polarized component of the light of the blue wavelength region incident from the optical unit 10 passes through the selective half-wave plate 251, becomes s-polarized light and is reflected by the polarizing beam splitter 255, and directed to the first objective lens 60.

Referring to FIG. 9B, when information is recorded and/or reproduced with respect to the HD DVD 1b, if the selective half-wave plate 251 receives a second voltage V2 (e.g., the selective half-wave plate 25 is in a power-on or higher power state), the p-polarized component of the light 11a of the blue wavelength region passes through the selective half-wave plate 251 without a change in polarization, passes through the polarizing beam splitter 255, and is directed to the second objective lens 70.

Since the amount of light respectively directed to the BD 1a and the HD DVD 1b may be maximized even when the optical path switching unit 250 is used, an optical efficiency is increased and thus high-speed operations requiring a large quantity of light may be obtained. FIGS. 8 through 9B illustrate an embodiment in which the optical path switching unit 250 is applied to the BD and HD DVD-compatible type optical pickup described with reference to FIGS. 5 and 6, and is intended for exemplary purpose only. The optical path switching unit 250 may be applied to the optical construction of FIG. 7 in place of the optical path switching unit 50. In this case, the wave plate 17 is arranged on the optical path between the optical path switching unit 250 and the first and the second objective lenses 60 and 70 instead of being arranged in the optical unit 110.

In FIGS. 8 through 9B, the optical path switching unit 250 includes a cubic-type polarizing beam splitter 255. Alternately, the polarizing beam splitter 255 may be a plate-type polarizing beam splitter.

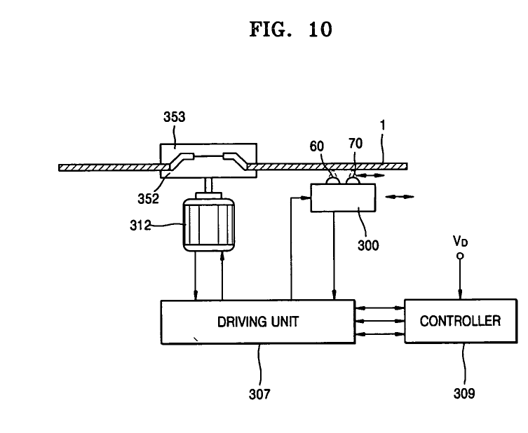

FIG. 10 is a schematic view of an optical recording and/or reproducing apparatus adopting an optical pickup according to the present invention. Referring to FIG. 10, the optical recording and/or reproducing apparatus includes: a spindle motor 312 to rotate an optical disc 1; an optical pickup 300 installed to move along a radial direction of the disc to reproduce information recorded on the optical disc 1 and/or record information to the optical disc; a driving unit 307 to drive the spindle motor 312 and the optical pickup 300; and a controller 309 to control focus, tracking and/or tilt servos of the optical pickup 300. The optical recording and/or reproducing apparatus further includes a turn table 352 and a clamp chucking the optical disc 353.

The optical pickup 300 has the optical structure of an optical configuration according to aspect of the present invention shown in FIGS. 2-9B.

Light reflected from the optical disc 1 is detected by a photo detector included in the optical pickup 300 and is then transformed into an electrical signal through photoelectric-conversion. The electrical signal is inputted to the controller 309 through the driving unit 307. The driving unit 307 controls a rotational speed of the spindle motor 312, amplifies an inputted signal, and drives the optical pickup 300. The controller 309 sends a focus servo, a tracking servo and/or a tilt servo, and a command controlled based on the signal inputted from the driving unit 307 to the driving unit 307 to perform focusing, tracking and/or tilt operations of the optical pickup 300. The optical recording and/or reproducing apparatus adopting the optical pickup 300 can adopt the BD and HD DVD standards in a compatible manner (and possibly other media such as CDs and/or DVDs) and maximize light quantities directed to the BD 1a and the HD DVD 1b, respectively, and thus realize high speed operations.

Although the above descriptions describe the case where the optical pickup according to the present invention uses the next-generation DVD standards (i.e., the BD and the HD DVD standards), in a compatible manner, the present invention is not limited to this case. That is, the optical pickup of the present invention can be applied to a variety of systems requiring a plurality of objective lenses of different design specifications besides the BD and the HD DVD systems and be properly modified as required by those systems.

According to aspects of the present invention, since the light quantities respectively directed to the plurality of objective lenses may be maximized, optical efficiency is increased and thus a high speed operation can be performed.

Further, the optical pickup may adopt the information storage media of two different standards where the wavelength of the light used is the same, and the thickness of the information storage media and the NA are different, e.g., the BD and the HD DVD standards.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical pickup compatible with information recording media of different types, comprising:
an optical unit to illuminate light onto a received information storage medium and to receive light reflected back by the information storage medium so as to detect an information signal and/or an error signal;
a first objective lens to focus incident light so as to form a first light spot onto an information storage surface of the information storage medium;
a second objective lens to focus incident light so as to form a second light spot onto an information storage surface of the information storage medium; and
an optical path switching unit to electrically switch a proceeding direction of the light so that the light incident from the optical unit is reflected toward the first objective lens and transmitted toward the second objective lens.

2. The optical pickup of claim 1, wherein the optical unit comprises a blue light source to emit light of a blue wavelength region and one of the first and the second objective lenses is formed in accordance with a BD (blu-ray disc) standard and the other is formed in accordance with an HD DVD standard, such that the optical unit is compatible with the BD and the HD DVD.

3. The optical pickup of claim 2, wherein the optical unit further comprises at least one of a red light source to emit light of a red wavelength region and an infrared light source to emit light of an infrared wavelength region, and the optical unit is compatible with at least one of a DVD (digital video disc) and a CD (compact disc).

4. The optical pickup of claim 3, wherein the objective lens formed in accordance with the HD DVD standard is further compatible with at least one of a DVD and a CD.

5. The optical pickup of claim 1, further comprising a reflection mirror to reflect light that has passed through the optical path switching unit.

6. The optical pickup of claim 1, wherein the first and second objective lenses are installed in a single lens holder along a radial direction of the information storage medium.

7. The optical pickup of claim 1, wherein the optical path switching unit comprises an electrically switching Bragg grating.

8. The optical pickup of claim 7, wherein the Bragg grating comprises:
a liquid crystal layer that is interposed between a pair of substrates, the liquid crystal layer comprising liquid crystal drops entangled with chains and a polymer to fill a space between the liquid crystal drops, a refraction index difference between the liquid crystal drops and the polymer being adjusted by an electrical signal to selectively transmit or reflect/diffract incident light; and
transparent electrodes formed on inner surfaces of the substrate to produce an electric field in the liquid crystal layer.

9. The optical pickup of claim 1, wherein the optical path switching unit comprises:
a selective half-wave plate to selectively change polarization of light of a specific wavelength region that is incident from the optical unit by being electrically driven; and
a polarizing beam splitter to selectively transmit or reflect the light that is incident from the selective half-wave plate depending on the polarization of the light.

10. The optical pickup of claim 9, wherein the light of the specific wavelength region is light of a blue wavelength region.

11. The optical pickup of claim 9, wherein the selective half-wave plate is a liquid crystal plate formed to selectively act as a half-wave plate by being electrically driven.

12. An optical recording and/or reproducing apparatus comprising: an optical pickup that is installed to move along a radial direction of an information storage medium and reproduces information recorded on the information storage medium or records information to the information storage medium; and a controller to control the optical pickup, the optical pickup being the optical pickup of claim 1.

13. The apparatus of claim 12, wherein the optical path switching unit comprises an electrically switching Bragg grating.

14. The apparatus of claim 13, wherein the Bragg grating comprise:
a liquid crystal layer interposed between a pair of substrates, the liquid crystal layer comprising liquid crystal drops entangled with chains and a polymer to fill a space between the liquid crystal drops, a refraction index difference between the liquid crystal drops and the polymer being adjusted by an electrical signal to selectively transmit or reflect/diffract incident light; and
transparent electrodes formed on inner surfaces of the substrate to produce an electric field in the liquid crystal layer.

15. The apparatus of claim 12, wherein the optical path switching unit comprises:
a selective half-wave plate to selectively change polarization of light of a specific wavelength region incident from the optical unit by being electrically driven; and
a polarizing beam splitter to selectively transmit or reflect the light incident from the selective half-wave plate depending on the polarization of the light.

16. The apparatus of clam 15, wherein the light of the specific wavelength region is light of a blue wavelength region.

17. The apparatus of claim 15, wherein the half-wave plate comprises a liquid crystal plate.

18. The optical pickup of claim 2, wherein the optical path switching unit comprises an electrically switching Bragg grating.

19. The optical pickup of claim 18, wherein the Bragg grating comprises:
a liquid crystal layer that is interposed between a pair of substrates, the liquid crystal layer comprising liquid crystal drops entangled with chains and a polymer to fill a space between the liquid crystal drops, a refraction index difference between the liquid crystal drops and the polymer being adjusted by an electrical signal to selectively transmit or reflect/diffract incident light; and
transparent electrodes formed on inner surfaces of the substrate to produce an electric field in the liquid crystal layer.

20. The optical pickup of claim 2, wherein the optical path switching unit comprises:
a selective half-wave plate to selectively change polarization of light of a specific wavelength region that is incident from the optical unit by being electrically driven; and
a polarizing beam splitter to selectively transmit or reflect the light that is incident from the selective half-wave plate depending on the polarization of the light.

21. The optical pickup of claim 20, wherein the light of the specific wavelength region is light of a blue wavelength region.

22. The optical pickup of claim 20, wherein the selective half-wave plate is a liquid crystal plate formed to selectively act as a half-wave plate by being electrically driven.

23. An optical recording and/or reproducing apparatus comprising: an optical pickup that is installed to move along a radial direction of an information storage medium and reproduces information recorded on the information storage medium or records information to the information storage medium; and a controller to control the optical pickup, the optical pickup being the optical pickup of claim 2.

24. The apparatus of claim 23, wherein the optical path switching unit comprises an electrically switching Bragg grating.

25. The apparatus of claim 24, wherein the Bragg grating comprise:
a liquid crystal layer interposed between a pair of substrates, the liquid crystal layer comprising liquid crystal drops entangled with chains and a polymer to fill a space between the liquid crystal drops, a refraction index difference between the liquid crystal drops and the polymer being adjusted by an electrical signal to selectively transmit or reflect/diffract incident light; and
transparent electrodes formed on inner surfaces of the substrate to produce an electric field in the liquid crystal layer.

26. The apparatus of claim 23, wherein the optical path switching unit comprises:
a selective half-wave plate to selectively change polarization of light of a specific wavelength region incident from the optical unit by being electrically driven; and
a polarizing beam splitter to selectively transmit or reflect the light incident from the selective half-wave plate depending on the polarization of the light.

27. The apparatus of clam 26, wherein the light of the specific wavelength region is light of a blue wavelength region.

28. The apparatus of claim 26, wherein the half-wave plate comprises a liquid crystal plate.

29. The optical pickup of claim 3, wherein the optical path switching unit comprises an electrically switching Bragg grating.

30. The optical pickup of claim 29, wherein the Bragg grating comprises:
a liquid crystal layer that is interposed between a pair of substrates, the liquid crystal layer comprising liquid crystal drops entangled with chains and a polymer to fill a space between the liquid crystal drops, a refraction index difference between the liquid crystal drops and the polymer being adjusted by an electrical signal to selectively transmit or reflect/diffract incident light; and
transparent electrodes formed on inner surfaces of the substrate to produce an electric field in the liquid crystal layer.

31. The optical pickup of claim 3, wherein the optical path switching unit comprises:
a selective half-wave plate to selectively change polarization of light of a specific wavelength region that is incident from the optical unit by being electrically driven; and
a polarizing beam splitter to selectively transmit or reflect the light that is incident from the selective half-wave plate depending on the polarization of the light.

32. The optical pickup of claim 31, wherein the light of the specific wavelength region is light of a blue wavelength region.

33. An optical pickup for use with a recording/reproducing apparatus and which is compatible with media of different thicknesses using a common light wavelength, comprising:
an optical unit to illuminate light of the common wavelength onto an optical disc and to receive light reflected from the optical disc so as to detect an information signal and/or an error signal;
a first objective lens to condense incident light to form a first light spot onto an information storage surface of the optical disc;
a second objective lens to condense incident light to form a second light spot onto an information storage surface of the optical disc; and
an optical path switching unit to electrically switch the path of the light that is incident from the optical unit so as to the light toward the first objective lens or to transmit the light toward the second objective lens, wherein one of the first and second lenses is formed in accordance with Blu-ray disc (BD) standards and the other objective lens is formed in accordance with high definition digital versatile disc (HD DVD) standards.

34. The optical pickup according to claim 33, wherein the first objective lens is formed in accordance with a Blu-ray disc (BD) standard to be used when the optical disc is the BD and the second objective lens is formed in accordance with a high definition digital versatile disc (HD DVD) standard to be used when the optical disc is an HD DVD.

35. The optical pickup according to claim 34, wherein the second objective lens is further compatible with digital versatile disc (DVD) and/or compact disc (CD) standards.

36. The optical pickup according to claim 33, further comprising a single lens holder to hold the first and the second objective lenses to be disposed along a radial direction of the optical disc, and an actuator to drive the first and second objective lenses in a focus direction, a tracking direction and/or a tilt direction.

37. The optical pickup according to claim 33, further comprising a single lens holder in which the first and the second objective lenses are installed to have corresponding working distances varying according to thicknesses of each optical disc.

38. The optical pickup according to claim 33, wherein the optical path switching unit comprises an electrically switchable Bragg grating (ESBG) which selectively transmits and reflects according to different input voltage levels.

39. The optical pickup according to claim 33, wherein the optical disc is plural in number and comprises a Blu-ray (BD) disc and a high definition digital versatile disc (HD DVD) and one of the first and second objective lenses is formed in accordance with BD standards and selectively transmitted or reflected as a result of a driving of the optical path switching unit.

40. The optical pickup according to claim 33, further comprising first and second optical modules to emit second and third light with wavelengths appropriate for a DVD and/or a CD, respectively.

41. The optical pickup according to claim 40, wherein the first and second modules receive the second and the third light after the first and second light beams are reflected from the optical disc so as to detect an information reproducing signal and/or an error signal.

42. The optical pickup according to claim 41, wherein the first and/or second module comprises a hologram optical module for use with a DVD and a CD.

43. A recording/reproducing apparatus, comprising:
a spindle motor to rotate an optical disc;
the optical pickup of claim 33 installed to move along a radial direction of the disc to reproduce information recorded on the optical disc and/or record information to the optical disc;
a driving unit to drive the spindle motor and the optical pickup; and
a controller to control focus, tracking and/or tilt servos of the optical pickup.
